(19) United States
(12) Patent Application Publication
(10) Pub. No.: US 2026/0032440 A1
(43) Pub. Date: Jan. 29, 2026

(54) UNAUTHORIZED ACCESS PREVENTION IN A COMMUNICATIONS NETWORK

(71) Applicant: T-Mobile Innovations LLC, Overland Park, KS (US)

(72) Inventors: Anil Kumar MARIYANI, Ashburn, VA (US); Subramania Kaushik, Bellevue, WA (US)

(21) Appl. No.: 18/783,048

(22) Filed: Jul. 24, 2024

(51) Int. Cl. H04W 12/08; H04W 8/18; H04W 12/71; H04W 12/72

(52) U.S. Cl. CPC H04W 12/08; H04W 8/18; H04W 12/71; H04W 12/72

(57) ABSTRACT

Embodiments of the present disclosure are directed to systems and methods for preventing unauthorized access of a communications network. For example, the network may store a Physical Entity Identifier (PEI) and subscriber identity of authorized user equipment (UE) during attachment to the network and compare it to PEIs included in subsequent service requests from suspect UEs that are spoofing subscriber identities of the authorized UEs. For example, if the compared PEIs are different, the service request is rejected. In this way, the subsequent service requests can be verified as coming from authorized UEs, thereby preventing unauthorized access to the network.

### SUMMARY

The present disclosure is directed, in part, to preventing unauthorized access during establishment of a communication path between a suspect user equipment (UE) and a communications network, substantially as shown and/or described in connection with at least one of the figures, and as set forth more completely in the claims.

According to various aspects of the technology, when a communications network authenticates a UE to receive service, it typically considers the Physical Entity Identifier (PEI) of the UE. The PEI, such as the International Mobile Equipment Identity (IMEI), uniquely identifies the physical device. During an authentication process, the network verifies the PEI against an Equipment Identity Register (EIR) to ensure the device is not blacklisted and is authorized to access the network. This process ensures that only legitimate devices can establish an initial connection and receive services from the network. However, subsequent requests to establish data sessions, such as setting up 5G bearers, do not involve verifying the PEI of the UE. Once the UE is authenticated and granted access, the network assumes that any further requests from the UE are legitimate and does not recheck the PEI. This approach introduces potential vulnerabilities.

For example, the lack of PEI verification in these later requests can be exploited by fraudulent actors. If an attacker manages to imitate or spoof a subscriber identity of the authenticated UE, they could potentially establish data sessions and gain unauthorized access to the network. This could lead to various malicious activities, including data theft, unauthorized usage of network resources, and disruption of services.

By implementing a PEI verification process for these subsequent requests, these vulnerabilities can be mitigated. For example, by verifying the PEI for data session establishment requests, the network ensures that the requesting UE (e.g., a suspect UE) is the same UE that was initially authenticated. This additional layer of security makes it significantly more difficult for fraudulent actors to spoof subscriber identities and establish data sessions, thereby enhancing the overall security and integrity of the communications network.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed;

FIG. 4 illustrates a flow chart of an exemplary method for preventing unauthorized access of a communications network in which implementations of the present disclosure may be employed; and

FIG. 5 illustrates a flow chart of another exemplary method for preventing unauthorized access of a communications network in which implementations of the present disclosure may be employed.

FIG. 6 illustrates a flow chart of another exemplary method for preventing unauthorized access of a communications network in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunications network for illustrative purposes. However, it should be understood that the principles and techniques discussed herein are not limited to wireless networks alone. The concepts and methodologies can be equally applied to other types of communications networks, including but not limited to wired, satellite, and optical networks. These alternative networks are capable of supporting the functionalities and applications described, and their use falls within the scope of the present disclosure.

As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, when a communications network authenticates a UE to receive service, the process begins with the UE sending an initial registration request to the network. This request includes the PEI and subscriber identifier of the UE. The request is received by the Access and Mobility Management Function (AMF), which is responsible for handling the initial connection and mobility management of the UE. The AMF then forwards the PEI to the Unified Data Management (UDM) function for verification. Upon receiving the PEI from the AMF, the UDM queries a storage repository, such as a Unified Data Repository (UDR) or an EIR to check the status of the device. The EIR contains a database of PEI's, such as IMEI numbers, categorized into white, black, or grey lists. If the PEI is found on the black list, indicating that the device is stolen or unauthorized, the UDM informs the AMF to deny the registration request. If the PEI is on the white list, the UDM proceeds with further authentication steps. The UDM may also interact with a network storage device such as a UDR to verify the request or store information. For example, the UDM may store the PEI of the UE in the UDR. Once the PEI is verified and deemed legitimate, the UDM signals the AMF to proceed with the authentication process. The AMF may then coordinate with the Session Management Function (SMF) to establish the necessary data sessions or bearers for the UE.

Conventionally, after the initial authentication and authorization of the UE, subsequent requests to establish data sessions, such as setting up 5G bearers, follow a streamlined process. For example, when initiating a new data session, a session establishment request is sent to the AMF. The AMF, already having established security context with the UE from the initial authentication, does not re-verify the PEI of the UE. Instead, it may rely on the previously authenticated subscriber identity, such as a Subscription Permanent Identifier (SUPI), a Subscription Identifier (SUCI), a Generic Public Subscription Identifier (GPSI), and/or other subscription identifiers used in communications networks. The AMF forwards the session request to the SMF, which is responsible for managing the data session. The SMF interacts with the UDM and the UDR to retrieve the necessary subscriber profile and policy information. Throughout this process, the SMF relies on the subscriber identity authenticated during the initial registration, without rechecking the PEI. This streamlined approach introduces a potential vulnerability. If a fraudulent actor can imitate or spoof the authenticated subscriber identity, they can send session establishment requests to the AMF, which will be forwarded to the SMF without further PEI verification. This allows the attacker to potentially gain unauthorized access to network resources, leading to malicious activities such as data theft, unauthorized usage, and service disruption.

To address this issue, the present disclosure is directed to systems and methods for preventing unauthorized access of a communications network is provided. For example, a PEI verification process can be implemented for subsequent data session establishment requests. When the suspect UE initiates a new data session, the SMF receives the request, which includes the PEI value of the suspect UE and the subscriber identifier of the authorized UE in the session establishment message. The SMF then forwards this request to the UDM for verification. Upon receiving the request, the UDM queries the UDR to fetch the initially stored PEI associated with the authenticated subscriber identity. The UDM then compares this stored PEI with the PEI provided in the current request from the suspect UE. If the PEIs match, indicating that the suspect UE is the same UE that was initially authenticated (e.g., the authorized UE), the UDM approves the request and signals the SMF to proceed with establishing the data session. If the PEIs do not match, indicating that the suspect UE is different than the UE that was initially authenticated, the UDM rejects the request and signals an error (e.g., a 403-Forbidden and/or Unauthorized Device Access) to the SMF. Additionally, the UDM, or another network function, notifies the EIR of the discrepancy, which may trigger further security actions, such as black listing the PEI of the suspect UE and/or alerting network operators (e.g., through a Key Performance Indicator (KPI)). This verification process helps to ensure that only legitimate, authenticated UEs can request and establish data sessions, significantly enhancing the overall security and integrity of the communications network by preventing unauthorized access and potential fraudulent activities.

Accordingly, a first aspect of the present disclosure is directed to a system for preventing unauthorized access of a communications network. For example, the system includes a network storage device and a network device comprising one or more processors. The system further includes a non-transitory computer-readable media configured to, at a first time, receive a physical entity identifier (PEI) of an authorized user equipment (UE) and a subscriber identifier of the authorized UE, and to store both of the PEI of the authorized UE and the subscriber identifier of the authorized UE on the network storage device. The computer-readable media is further configured to, at a second time subsequent to the first time, receive a request from a suspect UE to establish a new data session with the communications network, the request comprising a PEI of the suspect UE and the subscriber identifier of the authorized UE. The computer-readable media is further configured to reject the request based on a determination that the PEI of the first UE is different than the PEI of the suspect UE.

A second aspect of the present disclosure is directed to a method for preventing unauthorized access of a communications network. For example, the method includes storing a Physical Entity Identifier (PEI) of an authorized user equipment (UE) and a subscriber identifier of the authorized UE one a network storage device. The method further includes receiving a bearer request from a suspect UE comprising a PEI of the suspect UE and the subscriber identifier of the authorized UE. The method further includes communicating the PEI of the suspect UE and the subscriber identifier of the authorized UE to one or more network functions.

A third aspect of the present disclosure is directed to a non-transitory computer-readable media that, when executed, cause a network device comprising one or more processors to perform operations for preventing unauthorized access of a communications network. For example, the computer-readable media is configured to maintain, during a period of time, service to an authorized user equipment (UE). The computer-readable media is further configured to receive, during the period of time that service is being maintained to the authorized UE, a bearer request comprising a Physical Entity Identifier (PEI) of a suspect UE and a subscriber identifier of the authorized UE. The computer-readable media is further configured to reject the bearer request based on a determination that the PEI of the first UE is different than the PEI of the suspect UE.

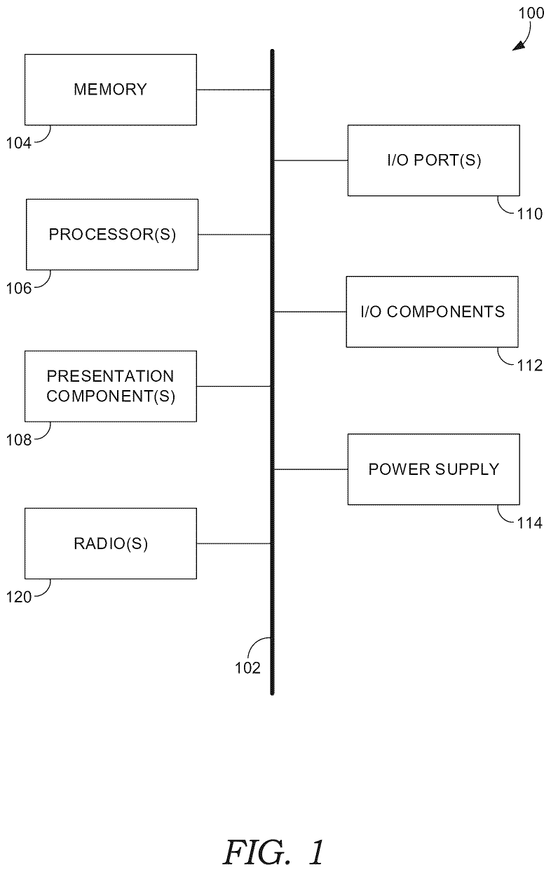

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

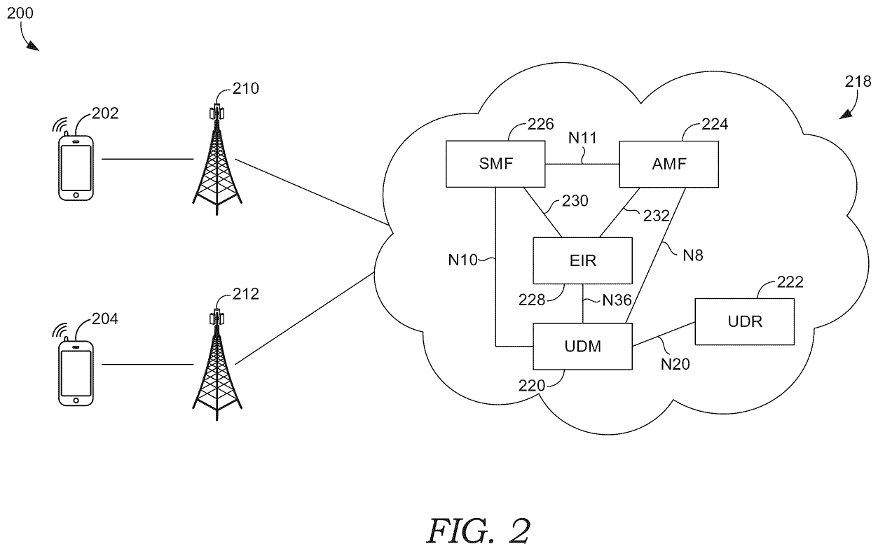

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunications network. At a high level, the network environment 200 may generally be said to comprise one or more UEs, such as a first UE 202 and/or a second UE 204, one or more base stations, such as a first base station 210 and/or a second base station 212, and a core network 218, though in some implementations, it may not be necessary for certain features to be present.

In some aspects, the network environment may comprise both the first UE 202 and the second UE 204, for example, when a PEI of a suspect UE (e.g., the second UE 204) is determined to be different than a PEI of an authorized UE (e.g., the first UE 202). In other aspects, the network environment 200 may not comprise the second UE 204 or the second base station 212, for example, when a PEI of a suspect UE is determined to be the same as a PEI of an authorized UE (e.g., the first UE 202), thereby verifying that the suspect UE is the authorized UE.

A PEI is a unique identifier assigned to a physical device within the network environment 200 that is used to authenticate and manage the device's access to network services (e.g., the core network 218). The PEI ensures that each device can be uniquely identified and tracked. Some non-limiting examples of PEI include International Mobile Equipment Identity (IMEI) typically used by smartphones or Media Access Control (MAC) typically used by wireless routers.

A subscriber identifier is a unique identifier that links a specific device to a particular subscriber account. The subscriber identifier helps ensure that each user's activities are accurately billed and attributed to the correct account. Non-limiting examples of subscriber identifiers include a Subscription Permanent Identifier (SUPI) used in 5G networks, which uniquely identifies each subscriber, a Subscription Concealed Identifier (SUCI), which protects the permanent identity (e.g., SUPI) of a subscriber during transmission, and/or a General Public Subscription Identifier (GPSI), which can be used for applications like messaging or voice services.

For purposes of this disclosure, it can be appreciated that references to the suspect UE may be made with the understanding that the suspect UE may, after identity verification, turn out to be the same as the authorized UE. Additionally, it can be appreciated that references to the suspect UE may be made with the understanding that the suspect UE may, after identity verification, turn out to be a different UE than the authorized UE that is attempting to gain unauthorized access to the core network 218. Accordingly, the term “suspect UE” may be used provisionally before the identity verification process associated with a request to initiate a new data session is completed in accordance with aspects herein.

The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the first base station 210 and/or the second base station 212 to which the first UE 202 and the second UE 204 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Each of the first base station 210 and the second base station 212 of the network environment 200 is configured to wirelessly communicate with UEs, such as the first UE 202 and/or the second UE 204. In aspects, any of first base station 210 and the second base station 212 may communicate with one or more of the first UE 202 and/or the second UE 204 using any wireless telecommunication protocol desired by a network operator, including but not limited to 3G, 4G, 5G, 6G, 802.11x and the like.

One or more network functions (NFs) of the core network 218 may communicate messages across the core network 218 to other NFs of the core network 218. As used herein, the term “network function” is used to describe a computer processing module and/or one or more computer executable services being executed on one or more computing processing modules. It should be appreciated that, while the network environment 200 is described in the context of a 5G environment, the same concepts may apply in other environments, such as a 4G environment. For example, the core network 218 may comprise NFs that include any one or more of a Unified Data Management (UDM) Function 220, a Unified Data Repository (UDR) 222, an Access and Mobility Management Function (AMF) 224, a Session Management Function (SMF) 226, and an Equipment Identity Register (EIR) 228. Notably, the preceding nomenclature is used with respect to the 3GPP 5G architecture; in other aspects each of the preceding NFs may take different forms, including consolidated or distributed forms that perform the same general operations. Additionally, depending on the network architecture, the UDM 220 and the UDR 222 may be integrated into a single platform or deployed as separate components. Accordingly, in some aspects, references to the UDM 220 or the UDR 222 may be a reference to both components in terms of functionality. In some architectures or protocols, the NFs may be given other names, however, the NFs herein refer to functions, not specifically identified components. Though the UDM 220, the UDR 222, the AMF 224, the SMF 226, and the EIR 228 are illustrated in the core network 218, the core network 218 may have more or fewer NFs than shown. For example, the core network 218 may include a network slice selection function (NSSF). Further, though the UDM 220, the UDR 222, the AMF 224, the SMF 226, and the EIR 228 are illustrated as disposed within the core network 218, it is expressly contemplated that the location in the network environment 200 is non-limiting. For example, the NFs described above may be disposed between the first base station 210 and/or the second base station 212 and the core network 218 (i.e., the network edge) or may be isolated as stand-alone components, or a combination of these.

The core network 218 is a service-based architecture and contains NFs defined by their function. The UDM 220, for example, is generally responsible for managing user data within the network. The UDR 222, for example, acts as a storage repository for various types of user-related data. The AMF 224, for example, is generally responsible for managing registration and mobility of UEs, such as the first UE 202 and/or the second UE 204, and achieves this by coordinating signaling between UEs, such as the first UE 202 and/or the second UE 204, and other NFs. The SMF 226, for example, is generally responsible for managing sessions between the network and one or more UEs, such as the first UE 202 and the second UE 204. The EIR 228, for example, is generally responsible for storing and managing PEIs of user equipment, helping to ensure that only authorized user equipment can access the network by categorizing them into white, black, and gray lists.

NFs within the core network 218 communicate a variety of messages to each other to perform their associated functions. For example, messages may correspond to registering a UE (such as the first UE 202 and the second UE 204) with the network, registering of a service provided by an NF, requesting information from the destination NF, providing information to the source NF, subscribing to notifications from an NF, providing notifications to NFs that an event has occurred, requesting deletion of specific information stored by an NF, and the like. Information given or provided by NFs to other NFs may include subscription information associated with a particular subscriber of the network, session information associated with a particular session in the network, and/or information associated with authentication of a UE (such as the first UE 202 and the second UE 204), for example, a PEI and/or a subscriber identity of the UE.

The NFs within the core network 218 communicate with other NFs to perform specified functions via designated interfaces. An interface is a connection point between NFs and allows NFs to bi-directionally communicate messages to other NFs. Particular interfaces are associated with specific NF pairs. For example, communications between the UDM 220 and the UDR 222 may occur on an N20 interface, while communications between the UDM 220 and the AMF 224 may occur on an N8 interface. Further, for example, communications between the UDM 220 and the SMF 226 may occur on an N10 interface, while communications between the UDM 220 and the EIR 228 may occur on an N36 interface. Additionally, for example, communications between the AMF 224 and the SMF 226 may occur on an N11 interface. Essentially, which interface a message will travel across depends on which NFs the message is between.

In addition to the aforementioned interfaces, the network environment 200 may include an interface 230 where communications may occur directly between the SMF 226 and the EIR 228. Additionally, in some aspects, the network environment may include an interface 232 where communications may occur directly between the AMF 224 and the EIR 228. Typically, the AMF 224 and the SMF 226 do not communicate directly with the EIR 228; however, in order to prevent unauthorized access to the core network 218, new interfaces (e.g., interface 230 and/or interface 232) may be established to facilitate notification of the EIR 228. Notifying the EIR 228 may comprise instructing the EIR 228 to put a PEI of a suspect UE on a gray list or a black list stored within the EIR 228.

When the first UE 202 initially attaches to the core network 218, the AMF 224 may help ensure that the first UE 202 is legitimate through a series of authentication steps. For example, the AMF 224 may help coordinate the verification of the stored credentials on the first UE 202 (e.g., a PEI and/or a subscriber identifier of the first UE 202) with the stored credentials in the core network 218 (e.g., UDM 220 and/or UDR 222). After successful confirmation, the AMF 224 help establish and maintain service for the first UE 202. For purposes of this disclosure, an “initial” attachment may refer to any attachment in which a UE initiates a connection to a communications network, for example, when the UE is powered on after being switched off, when the UE roams into a new network, or switching from a Wi-Fi connection back to a cellular network.

In order to establish service following authentication, the UDM 220 may be selected during a registration process to manage the subscriber's data and provide services. Once the UDM 220 is selected, the AMF 224 may transfer the first UE's 202 PEI and subscriber identifier to the UDM 220. The UDM 220 may then write the PEI and/or subscriber identifier of the first UE 202 into the UDR 222 (e.g., at a first time). Additionally, as part of the registration process, the UDM 220 may compare the PEI of the first UE 202 with the EIR 228 to verify that the first UE 202 is not black listed. Upon successful verification, the UDM 220 may confirm the credentials and allow the AMF 224 to proceed with establishing core network 218 services to the first UE 202.

After service for the first UE 202 has been established with the core network 218, subsequent bearer requests (e.g., a request to establish a new data session) may arrive at the SMF 308 (e.g., at a second time). Typically, the SMF 226 applies the appropriate network policies and sets up the bearer based on the request including a subscriber identifier of the first UE 202; however, in order to prevent unauthorized access to the core network 218 from a suspect UE that is different than the first UE 202 (e.g., the UE 204), the SMF 226 may implement further security measures. In this way, unauthorized access to the core network 218 can be prevented when the suspect UE is spoofing the subscriber identifier of the first UE 202. For example, the SMF 226 may communicate a PEI of the suspect UE, which may be included in the bearer request, to one or more network functions, such as the UDM 220.

In the process of verifying subsequent bearer requests, the UDM 220, upon receiving the PEI of the suspect UE and the subscriber identifier of the first UE 202, may search and retrieve records from the UDR 222 associated with the subscriber identifier of the first UE 202. The UDM 220 may then compare the PEI of first UE 202 from the stored records with the PEI of the suspect UE from the bearer request. If a determination is made that the PEI of the first UE 202 (e.g., the authorized UE) is different than the PEI of the suspect UE, the bearer request is rejected. For example, when the suspect UE is a second UE 202 different from the first UE 202. If a determination is made that the PEI of the first UE 202 is the same as the PEI of the suspect UE, the bearer request is accepted. For example, when the suspect UE is the first UE 202.

When the bearer request is rejected, the UDM 220 may notify the SMF 226 and include one or more error codes (e.g., 403 Forbidden and/or Unauthorized Device Access) to identify the specific reasons for rejection. Upon receiving the message, the SMF 226 may update its session management records and log the event for security auditing (e.g., implement a KPI) or notify the EIR 228. In order to notify the EIR 228 of the suspect UE (e.g., to register the PEI of the suspect UE on the black list), the interface 230 may be established, which may provide a direct interface between the SMF 226 and the EIR 228. In some aspects, the UDM 220 may notify the EIR 228 of the PEI of the suspect UE on the N36 interface.

Upon receiving the rejection from the UDM 220, the SMF 226 may relay the information to the AMF 224, which then informs the suspect UE. For example, upon receiving the notification from the SMF 226, the AMF 224 may process the information and prepare a response for the suspect UE. Additionally, similar to the SMF 226, the AMF 224 may notify the EIR 228 of the PEI of the suspect UE on the interface 232, which may be established to provide a direct interface between the AMF 224 and the EIR 228.

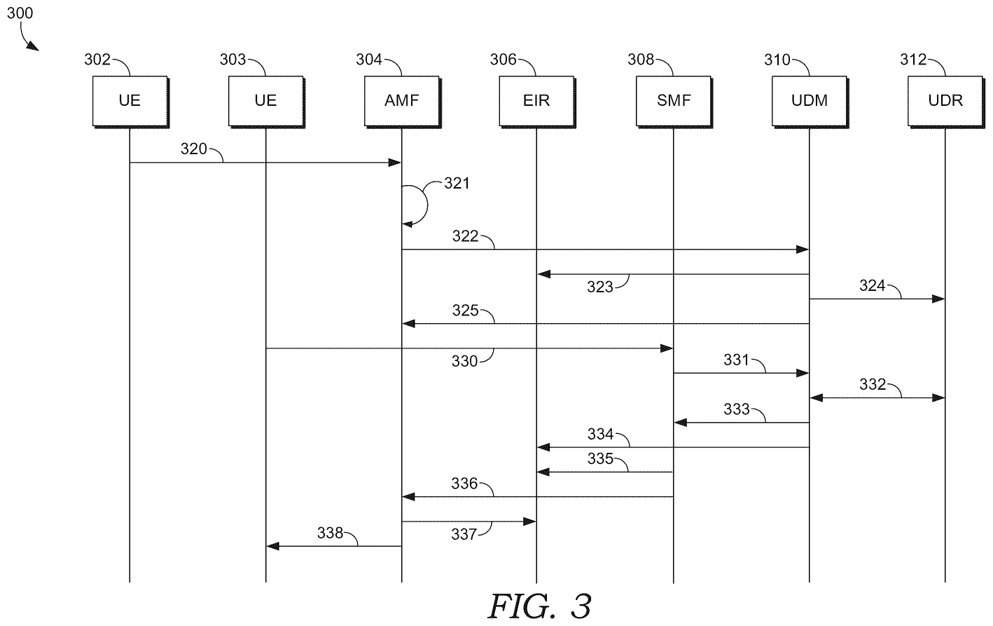

Turning now to FIG. 3, a flow diagram is illustrated in accordance with one or more aspects of the present disclosure. A flow diagram 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs and a user equipment. The flow diagram 300 may be relevantly said to include a first UE 302, a second UE 303, an AMF 304, a EIR 306, a SMF 308, a UDR 310, and a UDR 312. In some aspects, the first UE 302 may be the same or similar to the first UE 202, the second UE 303 may be the same or similar to the second UE 204, the AMF 304 may be the same or similar to the AMF 224, the EIR 306 may be the same or similar to the EIR 228, the SMF 308 may be the same or similar to the SMF 226, the UDM 310 may be the same or similar to the UDM 220, and the UDR 312 may be the same or similar to the UDR 222. Notably, the preceding nomenclature is used with respect to the 3GPP 5G architecture; in other aspects, each of the preceding NF components may take different forms, including consolidated or distributed forms that perform the same general operations.

FIG. 3 illustrates an example method for preventing unauthorized access of a communications network. At a first step 320, the first UE 302 initially attaches to the communications network. At a second step 321, the AMF 304 coordinates a series of authentication steps comprising one or more network functions in order to verify the first UE 302 as an authorized UE. At a third step 322, the UDM 310 is selected to manage subscriber data and provide services to the first UE 302 and the AMF 304 may forward a PEI of the first UE 302 and a subscriber identifier of the first UE 302 to the UDM 310. At a fourth step 323, the UDM 310 may verify the credentials of the first UE 302 against a list maintained on the EIR 306. As a part of registering the UDM 310 with the first UE 302, at a fifth step 324, the first UDM 310 may write the PEI and/or subscriber identifier of the first UE 302 into the UDR 312 (e.g., at a first time). In some aspects, the UDM 310 simply verifies that the forwarded information from the AMF 304 matches with the previously stored information in the UDR 312 without writing additional information in the UDR 312. At a sixth step 325, the UDM 310 may confirm the credentials and allow the AMF 304 to proceed with establishing service to the first UE 302.

At a seventh step 330, the second UE 303 (e.g., a suspect UE) may send a bearer request to establish a new data session with the communications network, which may arrive at the SMF 308. The request may include a PEI of the second UE 303 and a subscriber identifier of the first UE 302. In order to prevent unauthorized access to the communications network, at an eighth step 331, the SMF 308 may communicate the PEI of the second UE 303 and/or the subscriber identifier of the first UE 302 received in the bearer request to one or more network functions, such as the UDM 310. At a ninth step 332, the UDM 310 may fetch the PEI of the first UE 302 from the UDR 312 and determine that it is different than the PEI of the second UE 303 received in the bearer request. Based on this determination, the UDM 310 may reject the bearer request and implement further security measures.

For example, at a tenth step 333, the UDM 310 may identify reasons for the rejection (e.g., error codes) and forward them to the SMF 308. Additionally, at an eleventh step 334, the UDM 310 may notify the EIR 306 of the PEI of the second UE 303. At a twelfth step 335, the SMF 308 may notify the EIR 306 of the PEI of the second UE 303 and may accomplish this on an established direct interface between the SMF 308 and the EIR 306. At a thirteenth step 336, the SMF 308 may relay the rejection to the AMF 304. At a fourteenth step 337, the AMF 304 may notify the EIR 306 of the PEI of the second UE 303 and may accomplish this on an established direct interface between the AMF 304 and the EIR 306. At a fifteenth step 338, the AMF 304 may process the rejection information received from the SMF 308 and prepare a response to the bearer request that is sent back to the second UE 303.

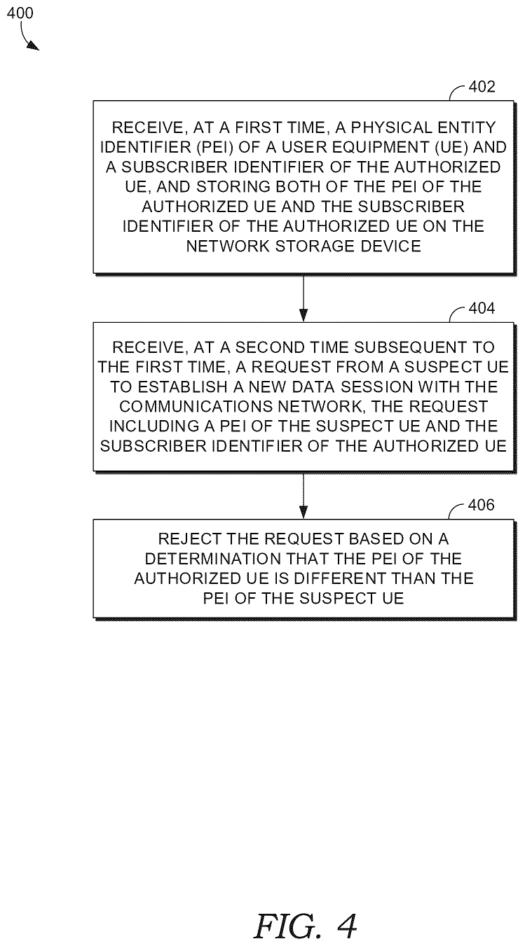

Turning now to FIG. 4, a flow chart is provided that illustrates one or more aspects of the present disclosure relating to a method 400 for providing an application on a user equipment with a unique identifier of the user equipment. At a first step 402, a Physical Entity Identifier (PEI) of an authorized user equipment (UE) and a subscriber identifier of the authorized UE is received at a first time and stored on a network storage device. In some aspects, the PEI and subscriber identifier of the authorized UE is received by a UDM. In such aspects, the first time may occur during a registration of the authorized UE with the UDM. In some aspects, the network storage device is a UDR. In some aspects, an authentication procedure is performed during an initial attachment of the authorized UE to the communications network prior to the first time. At a second step 404, a request from a suspect UE to establish a new data session with the communications network is received at a second time that is subsequent to the first time, the request including a PEI of the suspect UE and the subscriber identifier of the authorized UE. In some aspects, the UDM receives the request at the second time from an SMF. In some aspects, the request comprises a bearer request. At a third step 406, the request is rejected based on a determination that the PEI of the authorized UE is different than the PEI of the suspect UE.

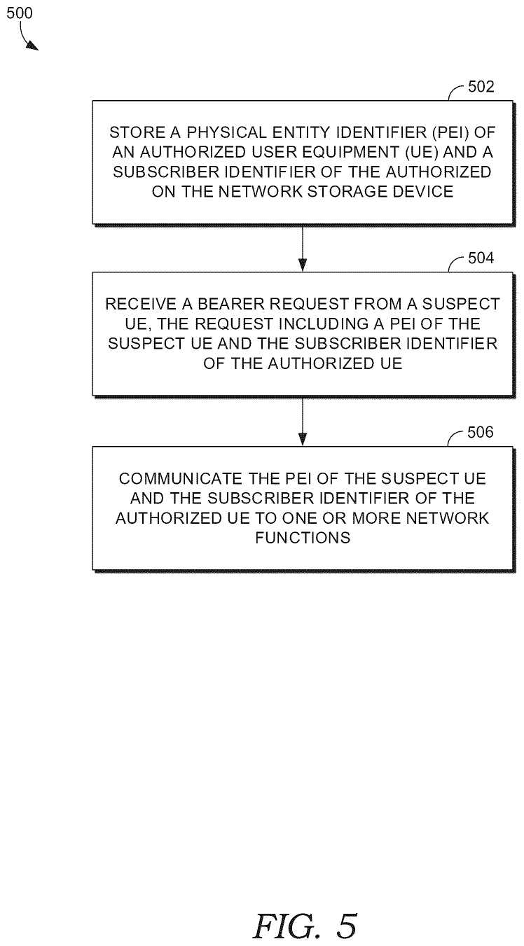

Turning now to FIG. 5, a flow chart is provided that illustrates one or more aspects of the present disclosure relating to a method 500 for preventing unauthorized access during an establishment of a communication path between a suspect user equipment (UE) and a communications network. For example, at a first step 502, a Physical Entity Identifier (PEI) of an authorized user equipment (UE) and a subscriber identifier of the authorized equipment is stored on a network storage device. At a second step 504, a bearer request from a suspect UE comprising a PEI of the suspect UE and the subscriber identifier of the authorized UE is received. At a third step 506, the PEI of the suspect UE and the subscriber identifier of the authorized UE is communicated to one or more network functions. In some aspects, the request is accepted based on a determination that the PEI of the authorized UE is the same as the PEI of the suspect UE. In some aspects, the request is rejected based on a determination that the authorized UE is different than the PEI of the suspect UE. In such aspects, an Equipment Identity Register (EIR) may be notified of the rejected request.

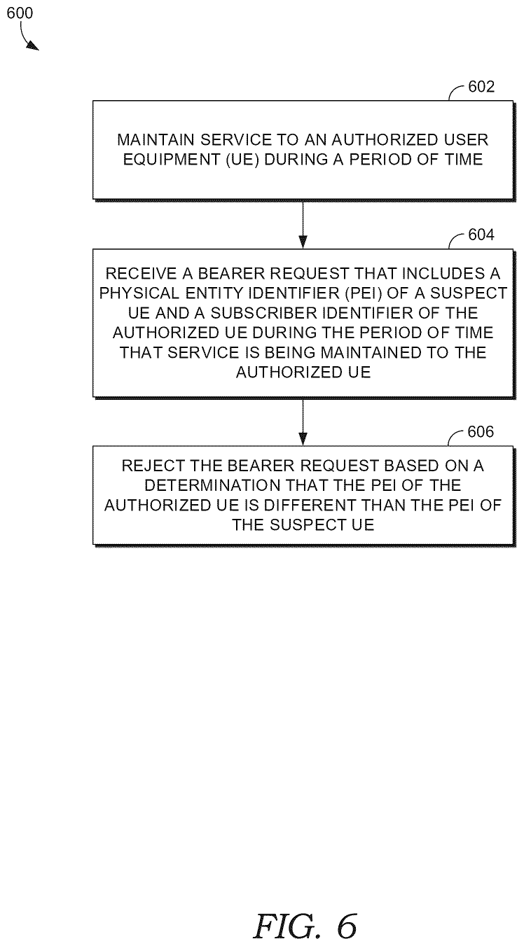

Turning now to FIG. 6, a flow chart is provided that illustrates one or more aspects of the present disclosure relating to a method 600 for preventing unauthorized access during an establishment of a communication path between a suspect user equipment (UE) and a communications network. For example, at a first step 602, service to an authorized user equipment (UE) is maintained during a period of time. At a second step 604, a bearer request comprising a Physical Entity Identifier (PEI) of a suspect UE and a subscriber identifier of the authorized UE is received during the period of time that service is being maintained to the authorized UE. At a third step 606, the bearer request is rejected based on a determination that the PEI of the authorized UE is different than the PEI of the suspect UE.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for preventing unauthorized access of a communications network, the system comprising:
a network storage device;
a network device comprising one or more processors; and
a non-transitory computer-readable media comprising executable instructions that, when executed, causes the network device to perform operations, the executable instructions comprising the steps of:
receiving, at a first time, a physical entity identifier (PEI) of an authorized user equipment (UE) and a subscriber identifier of the authorized UE, and storing both of the PEI of the authorized UE and the subscriber identifier of the authorized UE on the network storage device;
receiving, at a second time subsequent to the first time, a request from a suspect UE to establish a new data session with the communications network, the request comprising a PEI of the suspect UE and the subscriber identifier of the authorized UE; and
rejecting the request based on a determination that the PEI of the authorized UE is different than the PEI of the suspect UE.

2. The system of claim 1, wherein the network device is a Unified Data Management (UDM) function.

3. The system of claim 1, wherein the network storage device is a Unified Data Repository (UDR) associated with the communications network.

4. The system of claim 1, wherein the subscriber identifier is one of a subscription concealed identifier (SUCI), a subscription permanent identifier (SUPI), or a globally routable user agent public identity (GPSI).

5. The system of claim 1, wherein the network device receives the request at the second time from a Session Management Function (SMF).

6. The system of claim 1, wherein the first time occurs during a registration of the authorized UE with the network device.

7. The system of claim 1, wherein an authentication procedure is performed during an attachment of the authorized UE to the communications network prior to the first time.

8. The system of claim 7, wherein the authentication procedure comprises verifying that the PEI of the authorized UE positively matches with the subscriber identity of the authorized UE.

9. The system of claim 1, wherein the request to establish the new data session comprises a bearer setup request.

10. The system of claim 1, wherein rejecting the request further comprises generating an error code and providing the error code to a Session Management Function (SMF).

11. The system of claim 10, wherein the SMF implements a key performance indicator (KPI) to track the request.

12. The system of claim 1, wherein rejecting the request further comprises notifying an Equipment Identity Register (EIR) that the PEI of the suspect UE is associated with an attempt at establishing unauthorized access to the communications network.

13. The system of claim 12, wherein the EIR is directly notified of the attempt by a Session Management Function (SMF) through an interface between the SMF and the EIR.

14. The system of claim 12, wherein the EIR is directly notified of the attempt by an Access and Mobility Management Function (AMF) through an interface between the AMF and the EIR.

15. A method for preventing unauthorized access of a communications network, the method comprising:
storing a Physical Entity Identifier (PEI) of an authorized user equipment (UE) and a subscriber identifier of the authorized UE on a network storage device;
receiving a bearer request from a suspect UE comprising a PEI of the suspect UE and the subscriber identifier of the authorized UE; and
communicating the PEI of the suspect UE and the subscriber identifier of the authorized UE to one or more network functions.

16. The method of claim 15 further comprising accepting the request based on a determination that the PEI of the authorized UE is the same as the PEI of the suspect UE.

17. The method of claim 15 further comprising rejecting the request based on a determination that the authorized PEI is different than the PEI of the suspect UE.

18. The method of claim 17 further comprising notifying an Equipment Identity Register (EIR) of the rejected request.

19. A non-transitory computer-readable media comprising executable instructions that, when executed, causes a network device comprising one or more processors to perform operations for preventing unauthorized access of a communications network, the executable instructions comprising the steps of:
maintaining, during a period of time, service to an authorized user equipment (UE);
receiving, during the period of time that service is being maintained to the authorized UE, a bearer request comprising a Physical Entity Identifier (PEI) of a suspect UE and a subscriber identifier of the authorized UE; and
rejecting the bearer request based on a determination that the PEI of the authorized UE is different than the PEI of the suspect UE.

20. The media of claim 19 further comprising notifying an Equipment Identity Register (EIR) of the rejected request.
